(19) United States
(12) Patent Application Publication
(10) Pub. No.: US 2017/0252584 A1
(43) Pub. Date: Sep. 7, 2017

(54) Roping Down Escape System

(71) Applicant: Bornack GmbH & Co. KG, Ilsfeld (DE)

(72) Inventors: Klaus BORNACK, Schreyerhof (DE); Jürgen SCHÄFER, Neuenstadt (DE)

(21) Appl. No.: 15/507,193

(22) PCT Filed: Aug. 27, 2015
(86) PCT No.: PCT/EP2015/069679

§ 371 Date: Feb. 27, 2017

(30) Foreign Application Priority Data
Aug. 28, 2014 (DE) 10 2014 112 403.0

(51) Int. Cl. A62B 1/10

(52) U.S. Cl. CPC A62B 1/10

(57) ABSTRACT

An assembly includes first and second ropes and a suspension element. The first rope is securable to a first attachment in a work area. A person can be coupled to the first rope. The second rope is available for lowering the person. The suspension element is secured in a securing region. A force-transmitting coupling is creatable between the second rope and the suspension element. The first and second ropes are coupled to each other over a first lowering region. The second rope is decoupleable non-destructively from the first rope from an end of the first lowering region. A person can be lowered in a second lowering region by the second rope. The weight of the person in the second lowering region is transferable from the second rope via the suspension element to the securing region.

### CROSS-REFERENCE TO RELATED APPLICATIONS

The present application is a national phase application emerged from international patent application PCT/EP2015/069679, which claims the benefit of the filing date of German Patent Application No. 10 2014 112 403.0 filed on Aug. 28, 2014, the disclosures of which are hereby incorporated herein by reference.

### TECHNICAL FIELD

The present invention relates to a system and to a method for controlled roping down a person in an emergency situation out of a danger area and/or working area.

### TECHNOLOGICAL BACKGROUND

In many technical areas, for example in structural engineering or in the mounting and maintenance of wind power plants, works have to be performed, at large heights, by persons. The access to a working area at such large heights can often be reached only via one single way up and down (or one single staircase and leaving). In emergency situations, for example due a fire, the persons in the working area reside in great danger, in particular if the fire cuts off (or blocks) the only way up and down. For external rescue workers and other rescue devices, for example helicopters, a sufficient rescue time is often lacking.

In order to safeguard the way up and down of the working area, rescue ropes are often provided at positions located at a distance to the way up and down such that the persons to be rescued can be roped down along these rescue ropes in emergency situations. The rescue ropes must on one hand have a sufficient heat and fire resistance and on the other hand be suitable for roping down a person safely from a large height to the ground.

However, hereby, a contradiction often exists, because fire-resistant rescue ropes often have unsuitable properties, such as, for example, large weight and less suitable transportability, and sparsely suitable roping down properties. On the other hand, rescue ropes, which are lightweight and suitable for the roping down, often have a less good fire resistance.

DE 20 2014 000 428 U1 discloses a rescue device having a fire resistant suspension. A person to be rescued can be roped down one-time along an exit rope out of a danger area by means of the rescue device. The person is coupled to the exit rope via an exit device. Furthermore, the exit device is attached via a connection means to a rope clamp. The rope clamp is also attached to the exit rope. Furthermore, the rope clamp is attached via a safety rope to an attachment area. After the roping down of the person along a safety length, the rope clamp is decoupled from the exit device by means of destruction of a predetermined breaking point such that the force flow is transferred from the exit device via the rope clamp to the safety rope. Due to the destruction of the predetermined breaking point, the rescue device can perform a roping down operation only one-time.

### SUMMARY

There may be a need to provide a user-friendly and reusable rescue system for rescuing persons from large heights.

According to example embodiments of systems and methods for roping down (or lowering) of a person in an emergency situation in a controlled manner out of a working area located at a distance to a ground according to the appended independent claims.

According to a first aspect of the present invention, there is described a system (so-called roping down escape system) for roping down (or lowering) of a person in an emergency situation in a controlled manner out of a working area located at a distance to a ground. The system has a first roping down system (so-called boarding system), which is for boarding the person and which is attachable (or securable) to an attachment area (or securing area) in the working area, wherein the first roping down system (or first lowering system) has a first rope (or first cable) for roping down the person. Furthermore, the system has a second roping down system (so-called evacuation system) for roping down the person, wherein the second roping down system (or second lowering system) has a second rope (or second cable), to which the person is coupleable (directly or indirectly, for example by means of a rope pulley or a coupling element). Furthermore, the system has a suspension element, which is attachable to the attachment area in the working area, wherein the second roping down system is coupled to the suspension element such that a force-transmitting coupling is producible (or creatable) between the second rope and the suspension element. The first roping down system and the second roping down system are designed such that the second roping down system is coupled to the first roping down system in a first roping down region (or first lowering region), and the second roping down system can be roped down in the first roping down region from the attachment area along a first roping length (or first lowering length) by means of the first rope, and such that the second roping down system is decoupleable non-destructively from the first roping down system from an end of the first roping down region, and such that the person can be roped down in a second roping down region (or second lowering region) along a second roping length (or second lowering length) by means of the second rope. A weight force of the person in the second roping down region is transferable (or transmittable) from the second rope via the suspension element to the attachment area.

According to a further aspect of the present invention, there is described a method for roping down of a person in an emergency situation in a controlled manner out of a working area located at a distance from a ground. According to the method, a first rope of a first roping down system for roping down the person is attached (or secured) to an attachment area (or securing area) in the working area. A suspension element is attached at the attachment area in the working area. A second roping down system is coupled to the suspension element such that a force-transmitting coupling is producable between a second rope of the second roping down system, which is for roping down the person, and the suspension element. The first roping down system and the second roping down system are designed such that the person can be roped down in a first roping down region from the attachment area along a first roping length by means of the first rope, and the person can be roped down from an end of the first roping down region in a second roping down region along a second roping length by means of the second rope, wherein a weight force of the person in the second roping down region is transferable from the second rope via the suspension element to the attachment area.

The working area may define an area, which may be at a distance from a ground and in which the person may be acting for example for mounting or maintenance. The working area may represent, for example, an area of a building, a bridge or a wind power plant, any of which is located at a distance to the ground. An emergency situation may arise, for example, by a fire or other environment conditions in the working area, which block a way up and down from the ground to the working area.

The first roping down system (and/or the first rope) may be attached for example to a first attachment element and the suspension element is for example attached to a second attachment element at the working area. The attachment elements may be for example bolts or snap hooks, which may be attachable to corresponding devices (for example lugs or a corresponding bolt) in the working area. In particular, the first attachment element and/or the second attachment element may be designed to be attachable to corresponding devices in the working area in a detachable and/or replaceable manner.

The first roping down system may define a roping down system, by means of which the person may rope down from the working area along the first roping down region. The second roping down system may define a roping down system, in which the person may rope down, after the roping down within the first roping down region, along a second roping down region.

To this end, the first roping down system may have a first rope, along which the person may rope down from the working area in the direction to the ground along the first roping down region. The first rope may be attached for example directly within the working area by means of a first attachment element, or indirectly, as will be discussed further below, by means of a first rope pulley. The first rope may have a free end and may loosely hang down from the first attachment element in the direction to the ground.

The second roping down system may have the second rope, along which the person may rope down, following the first roping down region, along the second roping down region. The person to be rescued may further be coupled to the second rope so that he can rope down/or is a movable relatively to the second rope, or may rope down due to a rolling-off of the second rope together with the second rope. The person may be coupled to the second roping down system by means of a direct coupling to the second rope or by means of an indirect coupling to a second rope pulley described below.

In all states of operation of the system, the first rope and the second rope may be ropes that are each structurally separated. Accordingly, the first rope and the second rope may have same or different materials.

The suspension element may be attached for example to the second attachment element within the working area. At an end of the first roping down region, i.e. at a region of the suspension element that is at a distance to the second attachment element, the second rope may be attached in a force-transmitting manner (directly or indirectly, i.e. for example by means of a coupling element described below). In particular, the second attachment element and the second rope may be attached, respectively, at ends of the suspension element, which ends are at mutual distances and opposite to one another, to the latter (to the suspension element) in a force-transmitting manner. The second rope may be attached to the suspension element either directly or by means of a coupling element that is described further below or by means of a rope pulley.

The suspension element thus may act as a spacer element, which may put the second rope at a distance from the working area (i.e. the risk area and/or danger area). The suspension element may thus run from the attachment element in the working area out of the working area. Outside of the working area and thus outside of the danger area, the second rope may be attachably coupled and may hang in the direction to the ground. The attachment point of the second rope at the suspension element may thereby be fixed to an end of the suspension element or may be slidable along the suspension element, until the attachment point reaches the end of the suspension element.

Alternatively or in addition, the first rope and/or the second rope may be attached by means of a rope pulley (and/or a rope drum) that is described in more detail below, such that the roping down device, embodied for example as a sit harness, may be attached to the first rope and/or to the second rope, without an according relative movement existing between the roping down device and the according first rope and/or second rope.

Because the first rope may be attached directly in the first working area or for example indirectly via a first rope pulley and/or rope brake, in the case of a rescue operation, the second roping down system with the person to be rescued may be roped down initially along the first rope. The second rope may be attached to the roping down device and may not take on a weight force of the person within the first roping down region during the roping down operation. After the roping down along the first roping down region, the roping down device may decouple from the first rope automatically and non-destructively, for example by the roping down device sliding out of the end of the first rope, and by the second rope beginning to take on the weight force of the person along the second roping down region.

A non-destructive coupling may be understood such that a decoupling of the first roping down system and the second roping down system from one another may be performed without a destruction of coupling partners and/or without the provision of e.g. predetermined breaking points. Furthermore, a non-destructive decoupling may mean that after the decoupling, no more force may be transferred between the two coupling partners after the decoupling. For example, a force, in particular a weight force of the person to be rescued, may be transferred (or transmitted) in the coupled state between the first roping down system and the second roping down system. After the decoupling of the first roping down system from the second roping down system, no force may be transferred between the two systems. Nevertheless, the first roping down system and the second roping down system may have contacting elements and/or components even after the decoupling, wherein then no weight force may be transferred between these elements.

The non-destructive decoupling may be performed for example by application of mechanical and/or sensor-controlled couplings and/or by coupling elements described below or rope pulleys.

For example, a coupling between the first roping down system and the second roping down system may also be implemented by means of a magnetic coupling or by a mechanical or sensor-controlled switch.

Due to the non-destructive decoupling of the first roping down system from the second roping down system, there may be provided a system that may be reversible and repeatedly usable, because no predetermined breaking point may be necessary for the operation of the system according to the invention. For example, after the roping down of the person, the system may be set anew in an initial state, such that a further person can be roped down out of the working area. Thus, a plurality of persons may be roped down with one and the same system by means of repeated roping down operations. This may lead to an increased capacity for roping persons as well as to a reduction of the availability costs for such a roping down system, because solely one system for roping down of persons may have to be provided in order to perform a plurality of roping down operations.

The suspension element may bridge a region and/or the first roping down region from the working area up to approximately the end of the suspension element. After bridging the first roping down region, the second rope may take over the roping down operation from a coupling point at the suspension element down to the ground.

Using the device (or system) according to the invention, the first rope and the second rope may be formed of a material, which may be preferably suitable for roping and has for example a low weight. For example, the first rope and the second rope may be manufactured from steel ropes, plastic fibres, Kevlar or from natural fibres, in particular hemp fibres. For example, the first rope and/or the second rope may have an aramide mantle (or aramide solid matter) with a polyamide core.

On the contrary, the suspension element may be formed with a material that has a high temperature and fire resistance. In particular, the temperature and fire resistance of the suspension element may be higher than the temperature and fire resistance of the first rope and the second rope.

In an emergency situation, the first rope temporarily may take over the roping down function, until the person is roped down out of the danger area. Subsequently, the second rope, which may assume a force-transmitting coupling at the suspension element at a distance to the working area, may take over the roping down function, until the person may have reached the ground. If the fire spreads quickly within the working area, then the first rope may be damaged speedily. The time, in which the first rope may remain-resistant against the fire, may be sufficient to rope down the person out of the danger situation. Subsequently, the second rope may take over the roping down function. Because the second rope may be coupled to the working area by means of the fire-resistant suspension element, the second rope may take over the roping down function during a sufficiently long period of time, without being directly exposed to the fire in the danger area. Because the suspension element may not need to reach down to the ground, but only out of the working and/or danger area over a certain suspension region, a low weight system having good roping properties can be provided.

Furthermore, also a plurality of persons may be attached to the system according to the invention, in particular to the second rope.

The first rope may have a length of, for example, approximately 2 m to 20 m, preferably approximately 10 m (meter). The second rope may have a length of, for example, approximately 20 m to 200 m. The suspension element may accordingly have a length of about 2 m to 20 m.

According to an exemplary embodiment example, the suspension element may have a rail (or rack), a cable or a rope (or cable), in particular a steel rope. Beside steel as a fire-resistant material, also aramide and/or Kevlar may be employed. A rope or a rod as a suspension element may have a diameter of approximately 5.0 mm to approximately 20.0 mm, preferably 10 mm (millimetre). Furthermore, the suspension element may be formed by means of a fire-resistant coating and/or with a fire-resistant sheath. This may be possible in particular, because the suspension element may not need to take over roping tasks.

According to an exemplary embodiment example, the system may have a roping down device, to which the first rope and the second rope may be coupled and to which the person is coupleable. The roping down device may be formed such that the roping down device may be displaceable along the first rope and/or the second rope.

The roping down device may be formed to rope down the person along the first rope and the second rope. The roping down device may be guided and/or roll along the first rope and/or the second rope as a controllable roping wagon (for example including a controllable brake, in particular a centrifugal brake). The roping down device may be braked for example either by the person himself or automatically, for example by means of the centrifugal brake.

The roping down device may further have a security element, to which the person can be coupled. Thereby, the security element (e.g. a hook, a lug, a closable snap hook) may be formed such that the person can be coupled releasably and selectively to the roping down device. In this way, the person may move freely for example in the working area and may couple to the roping down device quickly and simply upon the occurrence of an emergency situation. Alternatively, the roping down device may also be formed such that the person wears the roping down device permanently on the body and, in an emergency situation, may be coupleable selectively and releaseably to the first rope.

In an exemplary embodiment, the roping down device may be a roping wagon, which can roll off along the first rope and can be braked by the person and/or automatically. At the same time, the roping down device may be fixed to the second rope, without a relative movement between the attachment point at the second rope and the roping down device itself being possible. During a roping down operation, the roping down device thus may roll along the first rope and may leave the first rope after the roping down along the first roping down region. To this end, the first rope may simply have a free end, wherein the roping down device may slide along the free end in a simple manner and may be decoupled non-destructively from the first rope. The length of the first rope and/or the position of the end of the first rope relative to the second rope may be designed such that, after decoupling of the roping down device from the first rope, the second rope may begin to transfer the weight force of the person.

This exemplary embodiment, in which the roping down device may be displaceable along the first rope and is thus movable relative to the first rope, and wherein the roping down device may be fixed to the attachment point at the second rope and may be attached to the second rope in a non-displaceable manner, may have the advantage, that no coupling over of the person may be necessary after the roping down along the first roping down region and the beginning of the second roping down region. Thus, there may be provided a so-called dead-man safe system.

According to a further exemplary embodiment, the first roping down system may have a first rope pulley, which may be attachable in the working area by means of the first attachment element. The first rope may be coupled to the first rope pulley such that the first rope may be unrollable from the first rope pulley or via the first rope pulley. For roping down along the first roping down region, the rope may, for example, be unrolled around the first rope pulley. Furthermore, the first rope may be reeled on the first rope pulley, such that upon roping down, the first rope may be unrolled from the rope pulley.

The (first, and/or second respectively further second, as described below) rope pulley may have, for example, a rope brake and a retaining (or recuperating) function (manually or by means of a retaining spring (e.g. a coil spring)), such that after roping down the person, the corresponding rope can be reeled again and the system can thus be used anew.

The first rope brake may further be controlled purposefully by the person. Alternatively, the first rope brake may be formed as a centrifugal brake, such that the higher the roping down velocity, the higher the braking force, such that a specified roping down velocity may be adjustable automatically and self-activating.

According to a further exemplary embodiment, the second roping down system may have a second rope pulley, wherein the second rope pulley may be coupled to the first rope such that the second rope pulley can be roped down with the first rope. Furthermore, the second rope may be coupled to the second rope pulley such that the second rope can be roped down by means of the second rope pulley.

The second rope pulley may be coupled directly to the first rope, in particular to a rope end of the first rope. The second rope pulley then may have, for example, no relative movement with respect to the first rope. This may mean that the first rope is unreeled until the second rope pulley may be roped down along the first roping down region.

Alternatively and as is discussed further below, a further second rope pulley, for example, may be coupled to the first rope, such that the second rope pulley may be coupled to the first rope indirectly via the further second rope pulley.

The second rope pulley may be coupled to the second rope, wherein the second rope may be, for example, reeled on the second rope pulley and, accordingly, is unrollable from the second rope pulley.

Alternatively, the second rope pulley may be formed as a rope brake, such that the second rope pulley is threaded on the second rope and the second rope pulley itself may control the roping down velocity of the second rope of the second rope pulley, for example by exertion of a friction force on the second rope. For example, the second rope pulley may have a centrifugal brake for this purpose.

Alternatively and as described further below, the second rope may be attached to an end of the suspension element. In this case, the second rope pulley may roll itself in the direction to the ground along the second rope. Thereby, the persons to be rescued may be coupled directly to the second rope pulley.

According to a further exemplary embodiment, the second roping down system may have a further second rope pulley, wherein the further second rope pulley may be connected to the first rope such that the further second rope pulley can be roped down along the first rope. The further second rope pulley may be coupled to the second rope pulley.

Thereby, the further second rope pulley may be fixedly connected, for example to an end of the first rope, such that no relative movement may exist between the further second rope pulley and the first rope. The first rope may then be roped down itself from the working area, for example by means of the first rope pulley described above.

Alternatively, the first rope may be fixed in the attachment area such that the further second rope pulley can roll off along the first rope until the end of the first roping down region is reached.

According to a further exemplary embodiment, the further second rope pulley may be coupled to the second rope pulley such that the further second rope pulley may be fixed to the second rope pulley and that the second rope can be roped down by means of the second rope pulley. The fixation of the further second rope pulley to the second rope pulley may effect that no relative movement may occur between the further second rope pulley and the second rope pulley. The second rope pulley may then be formed such that the second rope may be either reeled in the second rope pulley, or may be threaded in the second rope pulley and, accordingly, the second rope may be unrolled from the second rope pulley. In this case, a relative movement may occur between the second rope and the second rope pulley.

According to a further exemplary embodiment, the second rope may be attached to the further second rope pulley, wherein the second rope pulley may be coupled via the second rope to the further second rope pulley and can be roped down along the second rope. This means, that no direct fixation may be defined between the second rope pulley and the further second rope pulley, and the second rope pulley can be roped down from the further second rope pulley along the second rope in the direction of the ground. Hereby, the persons to be rescued may, for example, be fixed directly to the second rope pulley.

According to a further exemplary embodiment the second roping down system may have a coupling element, wherein the coupling element may be coupled to the first rope. The coupling element may further be coupled to the suspension element such that the coupling element may be movable along the suspension element within the first roping down region.

The coupling element may be formed, for example, as a shackle (or hoop) and may enclose the suspension element completely or partially. Thereby, an opening of the coupling element, through which the suspension element can be guided, may have, for example, a smaller diameter than an end stop of the suspension element as described below, such that such an end stop may disable the further displacement of the coupling element along the suspension element and such that a force-transmitting coupling may arise between the suspension element and the coupling element.

In an exemplary embodiment example of the present invention, the coupling element may be, for example, fixed directly to the first rope or indirectly by means of the further second rope pulley described above.

In other words, the coupling element may be attached to the further second rope pulley, such that the coupling element is coupled to the first rope by means of the further second rope pulley.

According to a further exemplary embodiment, the coupling element may be fixed directly to the first rope.

According to a further exemplary embodiment, the coupling element may be fixed to the second rope, wherein the second rope pulley can be roped down along the second rope.

According to a further exemplary embodiment, the suspension element (e.g. the steel rope) may have an end stop at the transition between the first roping down region and the second roping down region, which end stop may be designed such that the coupling element may be displaceable up to the end stop and can be blocked by means of the end stop. The coupling element may be coupled to the suspension element, for example, by means of a snap hook or by means of a lug at the suspension element. The end stop may be formed at a free end of the suspension element, wherein the end stop may have a larger diameter than e.g. the lug of the second attachment element.

According to a further exemplary embodiment, the end stop may have a damping element, which delays the displacement of the coupling element along the suspension element. The damping element may consist, for example, of a rubber band. In particular, if the coupling element abuts against the end stop during a roping down operation, an abrupt blocking can be prevented by means of the rubber band, and thus the roping down operation can be delayed by means of the damping element.

According to a further exemplary embodiment, the second roping down system may have a third rope pulley, which may be fixed to the suspension element, wherein the second rope may be coupled to the third rope pulley such that the second rope may be, e.g., unrollable by means of the third rope pulley. The third rope pulley may be formed according to the first or second rope pulleys described above.

According to a further exemplary embodiment, the third rope pulley may have a third rope brake, which may be configured to control a rolling off of the second rope from the third rope pulley. The third rope brake may be formed according to the first or second rope brakes described above.

According to a further exemplary embodiment example, the system may have a carrier element (e.g. a carrier plate, in particular a triangular carrier plate). The first attachment element and the second attachment element may be attachable, in particular at a distance to one another, to the carrier element. The carrier element may have a coupling region, which may be designed such that the carrier element may be attachable in the working area by means of the coupling region.

The carrier element may be formed in particular from a temperature and fire resistant material, for example steel. Solely one attachment point to the working area may be necessary by means of the carrier element. This may enable a quicker and simpler fixation of the system within the working area. In particular, the carrier element may be formed as a triangular carrier plate, wherein the first attachment element may be attachable in a first corner region of the carrier plate, the second attachment element may be attachable in a second corner region of the carrier plate, and the coupling region of the carrier plate to the working area may be formed in a third corner region of the carrier plate.

According to a further exemplary embodiment, the system may further have a stowage device. The first roping down system and the second roping down system may be arrangeable in the stowage device such that the first roping down system and the second roping down system may be stowed in the stowage device and that the first attachment element and the second attachment element may be attachable in the working area. The stowage device may be formed such that, upon a load on the roping down device, the stowage device may release the first roping down system and the second roping down system.

The stowage device may be formed, for example sack-like or as a box and/or a case. The stowage device may be designed such that the first roping down system, the second roping down system and/or, for example, the roping down device may be enclosed by the former (i.e. stowage device). The stowage device may be formed such that the first attachment element and/or the second attachment element may project out of the stowage device in order to be attached to the working area. Alternatively, the system may have the carrier element. In this case, only the coupling region of the carrier element may project out of the stowage device in order to be fixed to the working area. The stowage device may be sheathed in a fire resistant manner. Furthermore, the stowage device itself may represent an air-tight packaging and/or a fire-protected packaging. Furthermore, the stowage device may be sealed in order e.g. to protect the interior from harmful inclusions (or debris). Furthermore, a sealing that may be broken open may indicate a usage of the system.

Furthermore, the roping down device together with a coupling region may project out of the stowage device, such that the person may couple in an easy manner to the system and/or the roping down device.

In an emergency situation, the person may hang himself, for example, at the roping down device. Due to the weight force of the person, a tension may occur in the system, and the first roping down system and the second roping down system may leave the stowage device. Thereby, the stowage device may be designed such that the first roping down system and the second roping down system slide thereout or that, upon a load, the stowage device may have a predetermined breaking point and/or a predetermined crack position in order to release the system.

The stowage device thus may offer a good transportation possibility and a worthiness of protection for the system. During an inactive state, the system may hang in the working area and may be enclosed and protected by the stowage device. Only in an emergency situation, the person may hang (or hinge hinges) himself to the roping down device, and the stowage device may release the first roping down system and the second roping down system.

In the examples of the present invention described above, the connections between individual components can be connected with one another in particular inseparably, such that mis-connections (or mis-hookings, or mis-hingings) which may lead to a malfunction of the whole system, can be avoided. Mis-connections may often be caused precisely in panic situations. Thereby, in particular the suspension element, the second rope pulley, the further second rope pulley, the coupling element and/or the further coupling element may be coupled to their corresponding coupling partner fixedly and unseparably to one another, such that such mis-connections may be avoided. Furthermore, all the components mentioned above (second rope pulley, further second rope pulley, suspension element, coupling element and further coupling element) and the connections among one another may be designed to receive and/or transfer, both in a non-destructive manner, a load of more than 400N (Newton), in particular more than 600N. By means of the system according to the invention, no predetermined breaking points may be necessary in order to guarantee the functionality. Thus, also the system may be possible as an irreversible system, because the system can be performed non-destructively. For example, the system may perform roping down operations repeatedly, without elements of the system having to be replaced.

It is noted that embodiments and/or examples of the invention have been described with reference to different subjects of the invention. In particular, some embodiment examples of the invention may be described by means of device claims and other embodiments of the invention by means of method claims. It will be clear for the person skilled in the art immediately upon the study of this application that, except where it is stated otherwise, in addition to a combination of features, which may belong to one type of subjects of the invention, also an arbitrary combination of features, which may belong to different types of subjects of the invention, is possible.

### BRIEF DESCRIPTION DRAWINGS

In the following, embodiment examples are described for a further explanation and a better understanding of the present invention with reference to the appended drawings. In the drawings:

FIG. 1 shows a schematic representation of a system for controlled roping down of a person according to an exemplary embodiment example of the present invention;

FIG. 2 shows the system of FIG. 1, which is arranged in a stowage device, according to an exemplary embodiment example of the present invention;

FIGS. 3 and 4 show schematic representations of an exemplary embodiment example of the system according to the invention, in which a second rope pulley and a further second rope pulley are employed and in which the ropes are stored in respective stowage devices;

FIG. 5 shows a schematic representation of an exemplary embodiment, wherein at least the second rope has provisions for attaching persons to two opposing rope ends;

FIG. 6 shows a schematic representation of an exemplary embodiment, in which the second rope is fixed to the further second rope pulley and the second rope pulley can be roped down relatively to the further second rope pulley;

FIGS. 7 and 8 show schematic representations of an exemplary embodiment of the system according to the invention, in which the first rope is attached to a first rope pulley and the second rope can be roped down at (or from) a second rope pulley; and

FIG. 9 shows a schematic representation of an exemplary embodiment, wherein the second rope is fixed to the coupling element and the second rope pulley can be roped down relative to the second rope.

### DETAILED DESCRIPTION OF EXEMPLARY EMBODIMENTS

Same or similar components in different figures are provided with same reference numerals. The representations in the figures are schematically.

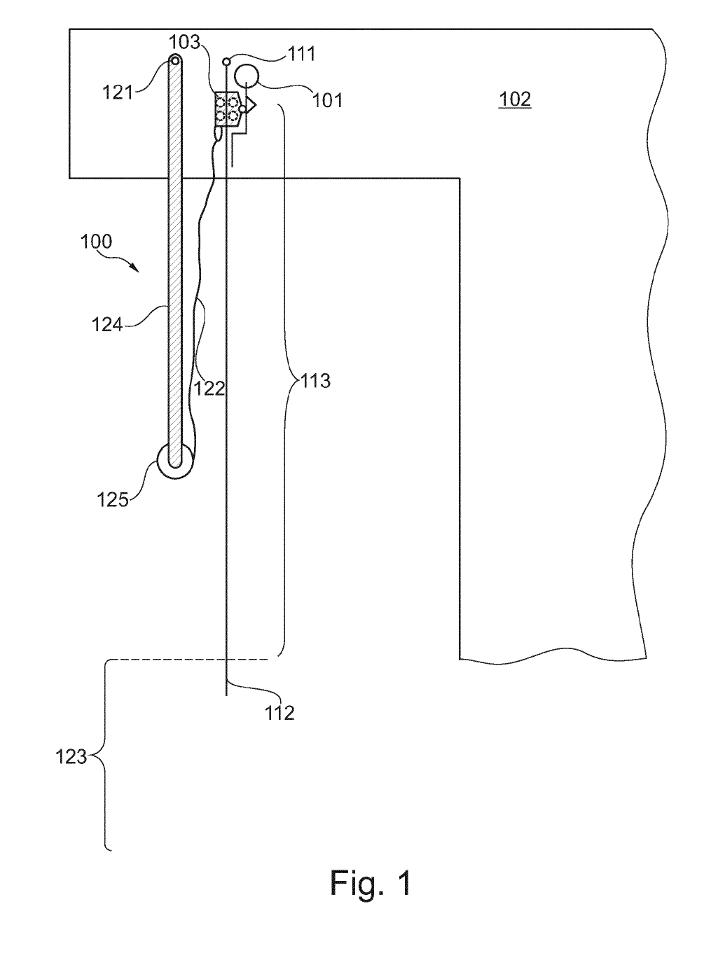

FIG. 1 shows a system 100 for controlled roping down of a person 101 in an emergency situation out of a working area 102 that may be located at a distance to a ground. A first roping down system (or lowering system, or roping system) is provided, which may be for roping down the person 101 and which may be attachable to an attachment area in the working area 102, wherein the first roping down system may have a first rope 112 for roping down the person 101. A second roping down system for roping down the person 101 may be provided, wherein the second roping down system may have a second rope 122, to which the person 101 may be coupleable directly or indirectly. A suspension element 124 may be attachable to the attachment area in the working area 102, wherein the second roping down system may be coupled to the suspension element 124 such that a force-transmitting coupling may be producible between the second rope 122 and the suspension element 124. The first roping down system and the second roping down system may be designed such that the second roping down system can be roped down in the first roping down region 113 of the attachment area along a first roping length by means of the first rope 112, and such that the second roping down system can be roped down along a first roping length by means of the first rope 112, and such that the second roping down system (or the person) may be decoupleable non-destructively from the first roping down system from an end of the first roping down region, and such that the person 101 can be roped down in a second roping down region 123 along a second roping length by means of the second rope 122. In the second roping down region 123, a weight force of the person 101 may be transferable from the second rope 122 via the suspension element 124 to the attachment area.

The working area 102 may define an area, which may be at a distance to a ground and in which the person 101 may operate, for example, for mounting or maintenance. The working area 102 may, for example, represent an according area of a building, of a bridge or of a wind power plant, any of which may be located at a distance to the ground. An emergency situation may arise, for example, by a fire or another damage arising in the working area 102, which may block a way up and down (or a staircase and a leaving) from the ground to the working area 102.

The first roping down system may define a roping down system, by means of which the person 101 can rope down himself from the working area 102 along the first roping down region 113. The second roping down system may define a roping down system, in which the person 101 can rope down himself after the roping down along the first roping down region 113 along the second roping down region 123.

In the embodiment example in FIG. 1, the first rope 112 may hang from the working area 102 in the direction to the ground, such that the person 101 can rope down from the working area 102 along the first roping down region 113 in the direction to the ground. The first rope 112 may have a free end and may hang down loosely from a first attachment element 111 in the direction to the ground.

The second roping down system may have the second rope 122, along which the person 101 can rope down himself, following the first roping down region 113, along the second roping down region 123. The suspension element 124 may be attached within the working area 102 by means of a second attachment element 121. The second rope 122 may be attached to a region of the suspension element 124 that may be at a distance to the second attachment element 121. In particular, the second attachment element 121 and the second rope 122 may be attached, respectively, to ends of the suspension element 103, which ends may be opposite and mutually at a distance to one another. The second rope 122 may be attached via a third rope pulley 125 to the suspension element 124.

The suspension element 124 thus may function as a spacer element, which may put the second rope 122 at a distance from the working area 102. The suspension element 124 thus may run from the second attachment element 121 in the working area 102 out of the working area. Outside of the working area 102 and thus outside of the danger area, the second rope 122 may be attached and may hang in the direction to the ground.

A roping down device 103 may be coupled to the first rope 112 and to the second rope 122. Furthermore, the person 101 may be coupled, in particular releasably, to the roping down device 103, for example by means of a snap hook. The roping down device 103 may be designed to rope down the person 101 along the first rope 112 and the second rope 122.

As shown in FIG. 1, the roping down device 103 may be guided and/or roll along the first rope 113 as a controllable rolling wagon, including e.g. a controllable brake, in particular a centrifugal brake.

Furthermore, the roping down device 103 may be coupled to the second rope 122, without a corresponding relative movement existing between the roping down device 103 and the according attachment point with the second rope 122.

The roping down device 103 further may have a securing element, to which the person 101 may be attached.

Because the first rope 112 may be attached directly to the working area 102, in the case of a rescue operation, the person may be roped down initially along the first rope 112. The second rope 122 may be attached to the roping down device 103 and may not take over a weight force of the person 101 during the roping operation within the first roping down region 113. After the roping down along the first roping down region 113, the roping down device 103 may decouple automatically from the first rope 112, for example by the roping down device 103 sliding out of the end of the first rope 112 and the second rope 122 beginning to take over the weight force of the person 101 along the second roping down region 123. The decoupling of the roping down device 103 from the first rope 112 may be effected, in particular non-destructively, by the roping down device 103 sliding out of the end of the first rope 112.

The suspension element 123, so to say, may bridge an area and/or partially the first roping down region 113 from the working area 102 to approximately the beginning of the second rope 122. After bridging the first roping down region 113, the second rope 122 may take over the roping operation from a coupling point and/or underneath the coupling point at the suspension element 124 down to the ground.

In an emergency situation, the first rope 112 may temporarily take over the roping down function, until the person 101 may be roped down out of the danger area. Subsequently, the second rope 122 may take over the roping down function until the person 101 may have reached the ground. If the fire expands quickly within the working area 102, then the first rope 112 may be damaged speedily. However, the time, within which the first rope 112 remains stable (or resistant) to the fire, may be sufficient to rope down the person 101 out of the dangerous situation.

Subsequently, the second rope 122 may take over the roping down function. Because the second rope 122 may be coupled to the working area 102 by means of the fire-resistant suspension element 124, the second rope 122 may take over the roping down function for a sufficiently long time duration, without being exposed directly to the fire in the danger area. Because the suspension element 124 may not need to reach down to the ground, but only may have to project out of the working and/or the danger area over a specific suspension region, a low weight system having good roping functions can be provided.

In the preferred embodiment of the system 100 in FIG. 1, the roping down device 103 may be a roping wagon, which can roll off along the first rope 112 and can be braked by the person 101 or automatically/self-actuatingly. At the same time, the roping down device 103 may be fixed to the second rope 122, without a relative movement being possible between the attachment point at the second rope 122 and the roping down device 103 itself. During a roping down operation, the roping down device 103 thus may roll off along the first rope 112 and leaves the first rope 112 after the roping down along the first roping down region 113. For this purpose, the first rope 122 may have a free end, wherein the roping down device 103 can slide over and beyond along the free end in an easy manner and can be decoupled from the first rope 112. The length of the first rope 112 and/or the position of the end of the first rope 112 relative to the second rope 122 may be designed such that, after decoupling the roping down device 103 from the first rope 112, the second rope 122 may begin to take on the weight force of the person 101. Thus, no manual coupling over of the person 101 may be necessary after the roping down along the first roping down region 113 and the beginning of the second roping down region 123.

The third rope pulley 125 may be attached to the suspension element 124, wherein the second rope may be coupled to the third rope pulley 125 such that the second rope 122 can roll off from the third rope pulley 125. The third rope pulley 125 may have a rope brake, which may be configured to control a roll off of the second rope 122 from the third rope pulley 125.

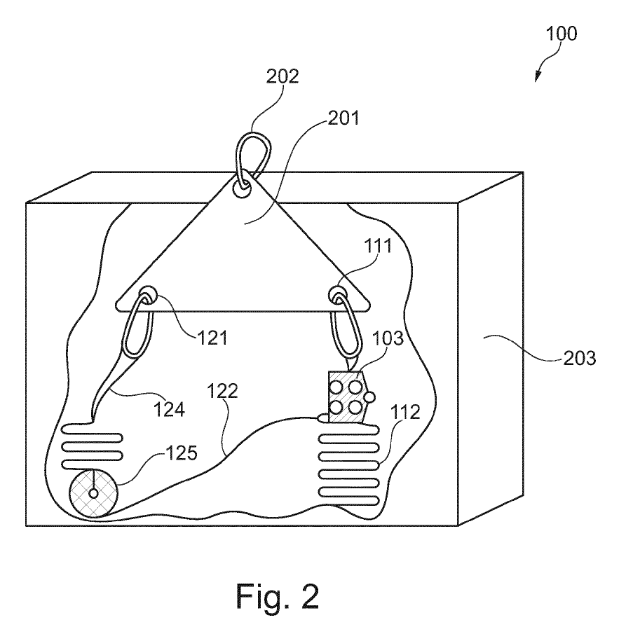

FIG. 2 shows the system 100, which comprises a stowage device 203. Furthermore, the system 100 of FIG. 2 may have a carrier element 201. The first rope 112, respectively the first attachment element 111, and the suspension element 124, respectively the second attachment element 121, may be attachable to the carrier element 201, in particular at a distance from one another. The carrier element 201 may have a coupling region 202, which may be designed such that the carrier element 201 may be attachable in the working area 102 by means of the coupling region 202.

The carrier element 201 may be formed in particular from a temperature and fire resistant material, for example steel. By means of the carrier element 201, solely one attachment point to the working area 102 may be necessary. This may enable a quicker and easier attachment (fixation) of the system 100 within the working area 102. In particular, the carrier element 201 may be formed as a triangular carrier plate, wherein the first attachment element 111 may be attachable in a first corner region of the carrier plate, the second attachment element 121 may be attachable in a second corner region of the carrier plate, and the coupling region 202 of the carrier plate to the working area 102 may be formed in a third corner region of the carrier plate.

The first roping down system and the second roping down system can be arranged in the stowage device 203 such that the first roping down system and the second roping down system may be stowed in the stowage device 203 and such that the first attachment element 111 and the second attachment element 121 may be attachable in the working area 102 (for example directly, or, as represented in FIG. 2, by means of the carrier element 201). The stowage device 203 may be formed such that, upon a load to the roping down device 103, the stowage device 203 releases the first roping down system and the second roping down system.

Furthermore, the roping down device 103 may, together with a coupling region, project out of the stowage device 203, such that the person 101 can couple himself in an easy way to the system 100 and/or to the roping down device 103.

In an emergency situation, the person 101 may hang himself, for example, to the roping down device 103. Due to the weight force of the person 101, a tension may arise in the system 100, and the first roping down system and the second roping down system may leave the stowage device 203. Thereby, the stowage device 203 can be formed such that the first roping down system and the second roping down system may slide out therefrom, or such that, upon a load, the stowage device 203 may have a predetermined breaking point and/or a predetermined crack position in order to release the system 100.

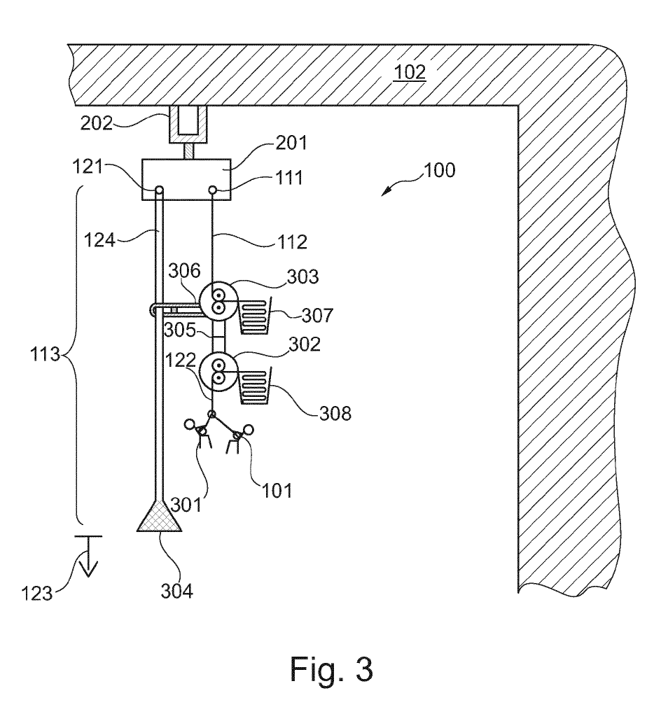

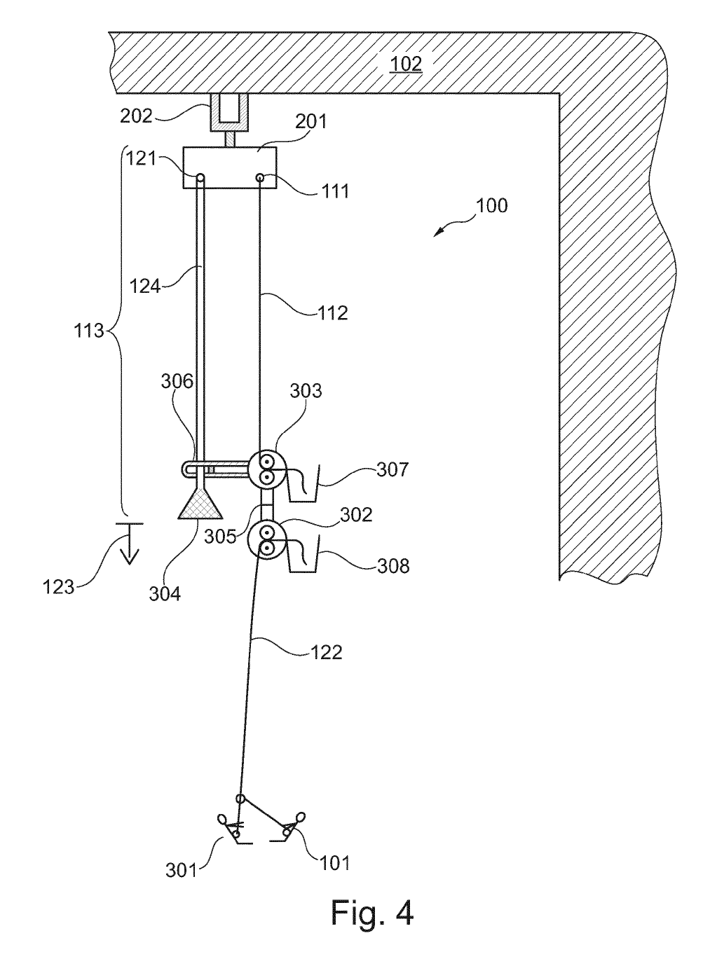

FIG. 3 and FIG. 4 show a further exemplary embodiment of the system 100. The system 100 has the carrier element 201. The first attachment element 111 and the second attachment element 121 may be attached to the carrier element 201, in particular at a distance from one another. The carrier element 201 may have a coupling region 202, which may be formed such that the carrier element 201 can be attached in the working area 102, for example to a supporter in the working area 102, by means of the coupling region 202.

The suspension element 124 may be attached to the carrier element 201 by means of the second attachment element 121. The second rope 122 may be fixed, via a coupling element 306, to a region of the suspension element 124 that may be at a distance to the second attachment element 121.

Furthermore, the first rope 112 may be attached to the carrier element 201 by means of the first attachment element 111. In contrast to the exemplary embodiment of FIG. 1, there may be provided a second rope pulley 302 and a further second rope pulley 303.

The first rope 112 may be coupled to and guided by the further second rope pulley 303. The further second rope pulley 303 may have a controllable and/or self-braking rope brake, such that the further second rope pulley 303 can be rolled off with a predetermined velocity along the first rope 112 starting from the carrier element 201. For example, the further second rope pulley 303 may have a centrifugal brake, in order to roll off along the first rope 112 with a predetermined velocity.

Thereby, the first rope 112 may be able to hang down loosely or, as is represented in the exemplary embodiment in FIG. 3, may be stowed in a stowage device 307. The stowage device 307 may be fixed, for example, to the further second rope pulley 303 and may be guided therewith.

Furthermore, the second rope pulley 302 may be attached to the further second rope pulley 303 by means of a further coupling element 305. The further coupling element 305 may consist, for example, of two snap hooks that are hooked with one another. In addition or alternatively to the second rope pulley 302, further roping down systems for other rescue purposes may be coupled to the further coupling element in a modular manner.

The second rope 122 may be coupled to and guided by the second rope pulley 302. For example, the second rope pulley 302 may have a controllable and/or self-braking rope brake (e.g. a centrifugal brake), such that the second rope pulley 302 may rope down specifically the second rope 122, to which at least one person 101 to be roped down may be hooked (or hinged) to, with a predetermined velocity starting from the further second rope pulley 303.

At least the first person 101 may be attached to an end of the second rope 122. Furthermore, also a further person 301 can be fixed to the end of the second rope 122. The second rope 122 may be attached to a second rope pulley 302. Thereby, the second rope 122 may be reeled on the rope pulley 302. In the embodiment example in FIG. 3, the second rope 122 may be guided between rolls of the second rope pulley 302, wherein a section of the second rope 122, which may not be located between the persons 101, 301 to be secured and the second rope pulley 302, is stowed in a further stowage device 308, for example in a rope sack. The further stowage device 308 is fixed, for example, to the second rope pulley 302.

In the embodiment in FIG. 3, the coupling element 306 may be fixed to the further second rope pulley 303, to a further coupling element 305 or the second rope pulley 302. The coupling element 306 may, for example, a shackle (or hoop), which may enclose the suspension element 124 and which may be displaceable along the suspension element 124. An end stop 304 may be formed at a free end of the suspension element 124, wherein the end stop 304 may have a larger diameter than a pass-through-opening of the further coupling element 306, through which the suspension element 124 may be guided.

In an emergency case, the persons 101, 301 may initially secure themselves to the free end of the second rope 122. Subsequently, the persons 101, 301 to be secured may be roped down by roping down the further second rope pulley 303 along the first rope 111. Thereby, at the same time, the coupling element 306 may be guided along the suspension element 124 (see FIG. 3). After the persons 101, 301 to be secured may have roped down along the whole first roping down region 113 and, for example, the coupling element 306 may have reached the end stop 304, a force-transmitting coupling between the second rope pulley 302 and the suspension element 124 may be produced and the first rope 112 may be relieved. This relief of the first rope 112 may correspond to a non-destructive decoupling of the second roping down system from the first roping down system. Accordingly, from now on, the persons 101, 301 to be secured are roped down along the second roping down region 123 by means of the second roping element (second rope pulley) 302. Thereby, the second rope 122 may roll off from the second rope pulley 302 and/or may be guided with a defined roping velocity, until the persons 101, 301 to be secured may have roped down along the second roping down region 123 (see FIG. 4).

The suspension element 124 thus may act as a prolonged (or extended) abutment. The end stop 304 may further have a damping device (i.e. a spring-based, pneumatic-based or hydraulic-based shock absorber), such that, upon abutment of the coupling element 306 against the end stop 304, the velocity may be reduced slowly and/or the deceleration may be damped.

Furthermore, the damping device may be formed in the suspension element 124 as a load impact damping, in order to dampen the impact of the coupling element 306 on the end stop 304. The load impact damping may have, for example, a shock absorber (or band shock absorber) and/or a deformable metal part, which may be arranged between a section of the suspension element 124 and the end stop 304.

The suspension element 124 may, for example, be formed as a steel rope having an end protection and a pull-through protection (or rim hole height protection), or as an aramide rope. The suspension element 124 may have a diameter of, for example, approximately 8 millimetres.

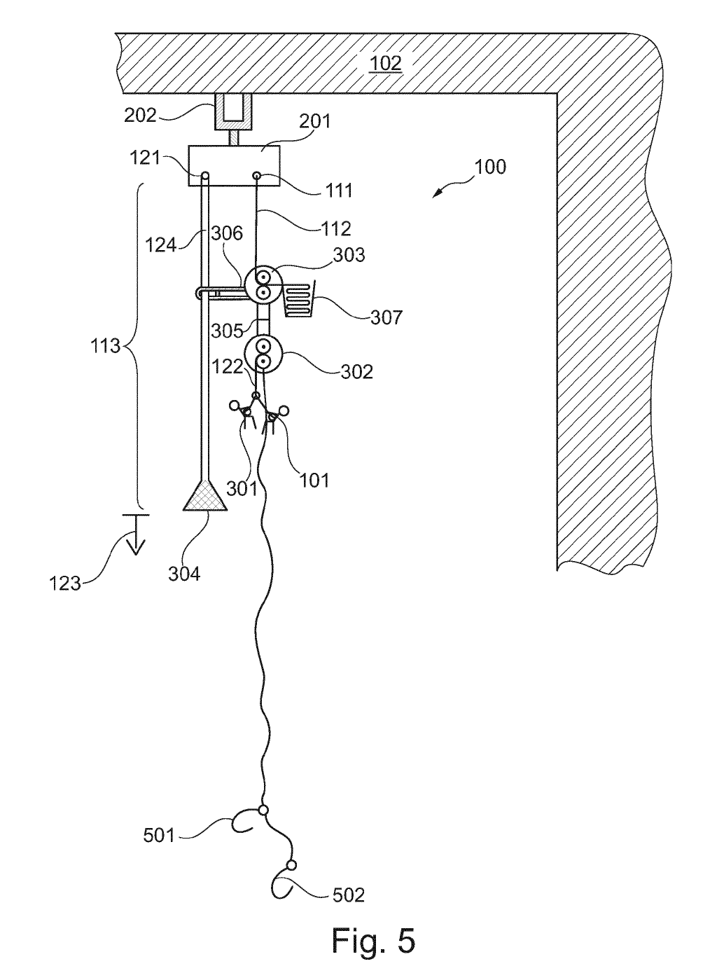

FIG. 5 shows a further exemplary embodiment of the system 100, which has almost the same features and describes the same roping down operation as the exemplary embodiment of FIG. 3 and FIG. 4.

By contrast to the exemplary embodiment of FIG. 3 and FIG. 4, the embodiment in FIG. 5 may have a second rope 122, at an end of which the persons 101, 301 may be secured. Securing regions 501, 503 may be formed at an opposite end of the second rope 122, to which further persons to be roped down can be attached.

A roping down operation can be performed repeatedly by means of the roping down system in FIG. 5. The second rope 122 may be guided around the second rope pulley 302, wherein the respective rope ends of the second rope 122 may hang down freely.

In a first roping down operation, the persons 101, 301 to be rescued may, for example, be hanged (or hinged), for example, to a first rope end of the second rope 122, and may be roped down (see FIG. 5).

During the roping down of the persons 101, 301, the second rope end of the second rope 122 may be pulled in the direction to the second rope pulley 302. Thereby, the second rope 122 may be formed so long that, after termination of the roping operation, the securing elements 501, 502 may be pulled towards and to the second rope pulley 302.

For performing a second roping operation, the further second rope pulley 303 may be pulled along the first rope 112 in the direction to the working area 102. After the further second rope pulley 303 may have been pulled in the working area 102 and/or in the vicinity of the carrier element 201, further persons can secure themselves to the securing elements 501, 502 and rope down in the direction to the ground. Thereby, i.e. with the weight force of the persons to be roped down, the securing elements 501, 502 at the first rope end of the second rope 122 may be pulled again and anew in the direction to the second rope pulley 302.

Furthermore, the embodiment example in FIG. 5 shows exemplarily that it is also not necessary to provide a stowage device 307 and/or a further stowage device 308.

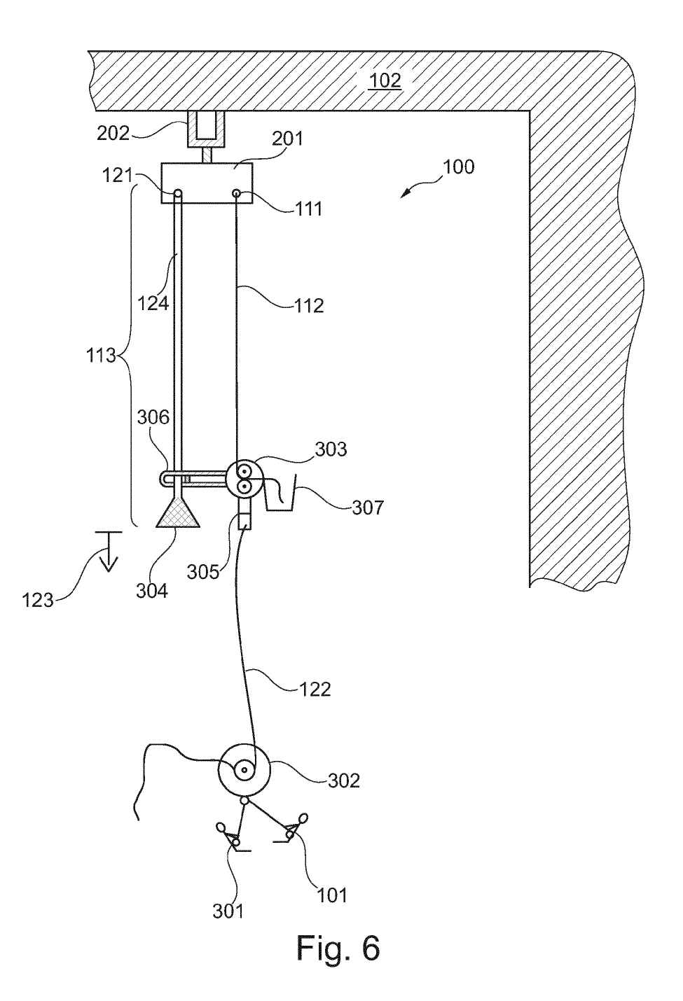

FIG. 6 shows a further exemplary embodiment of the system 100, which has almost the same features and describes the same roping down operation as the exemplary embodiments of FIG. 3 through FIG. 5.

By contrast to the systems 100 of FIG. 3 through FIG. 5, the system 100 of FIG. 6 may have a second rope pulley 302, which may rope itself down along the second rope 122 from the further second rope pulley 303 in the direction to the ground.

The second rope 122 may be coupled fixedly with one end to the further second rope pulley 303 and/or may be fixed via a further coupling element 305 to the further second rope pulley 303. In other words, there may exist no relative movement between the second rope 122 and the further second rope pulley 303.

The second rope pulley 302 may be attached via the second rope 122 to the further second rope pulley 303. In other words, the second rope pulley 302 can move relative to (or from) the further second rope pulley 303. The second rope pulley 302 may rope down, so to say, along the second rope 122 in the direction to the ground, in particular after the coupling element 306 may have reached the abutment (or end stop) 304 and the first rope 112 may be relieved and/or the second roping down system may be decoupled non-destructively from the first roping down system.

Thereby, the persons 101, 301 to be rescued may be fixed to the second rope pulley 302.

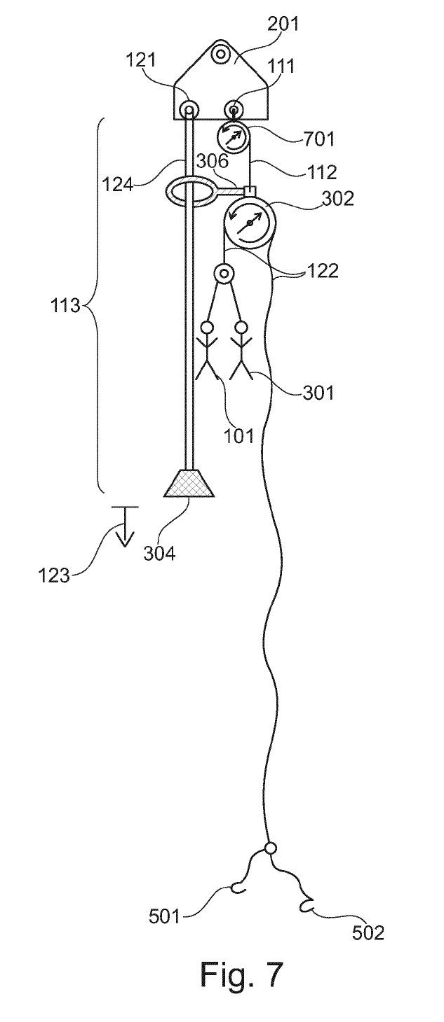

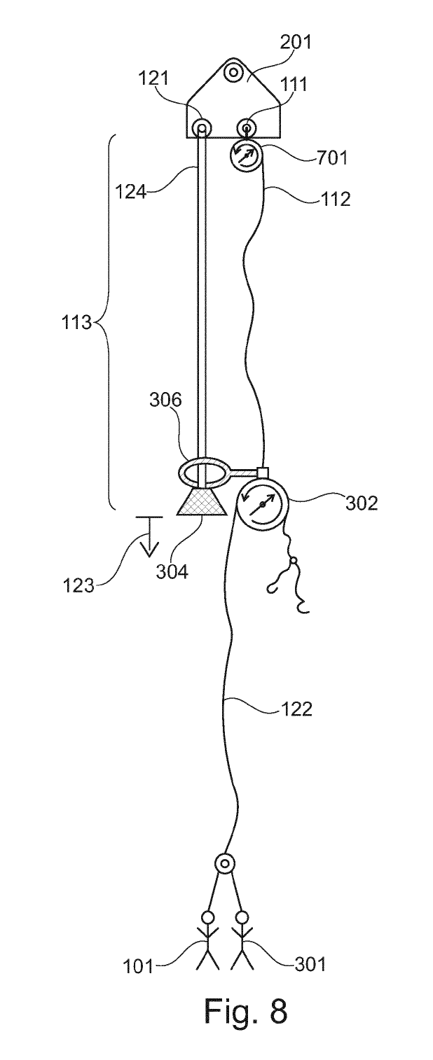

FIG. 7 and FIG. 8 show schematic representations of a further exemplary embodiment of the system 100 according to the invention, in which the first rope 112 is attached to a first rope pulley 701 and the second rope 122 can be roped down at (or from) a second rope pulley 302.

The carrier element 201 can be fixed in the working area 102. The first rope 112 may be attached to the carrier element 101 via the first rope pulley 701 at an attachment element 111. The suspension element 124 may be attached to the second attachment element 121.

The first rope 112 can be roped down from the first rope pulley 701. The first rope pulley 701 may be fixed to the carrier element 101, such that no relative movement may be provided between the first rope pulley 701 and the carrier element 101. The second criterion 302 may be fixed to an end of the first rope 112, such that no relative movement may be provided between the rope end of the first rope 112 and the second rope pulley 302.

Furthermore, the coupling element 306, which may be coupled displaceably to the suspension element 124, may be attached to the second rope pulley 302.

The second rope 122 may be reeled on the second rope pulley 302 or may be guided around the second rope pulley 302 such that the second rope pulley 302 can act as a rope brake for the second rope 122.

Corresponding securing elements 501, 502 may be provided at corresponding rope ends of the second rope 122, such that the persons 101, 301 to be rescued can be secured and/or fixed to a rope end of the second rope 122.

In addition, corresponding stowage devices 307, 308 may be provided (not shown), in order to stow the corresponding ropes 112, 122 and do not let them hang down.

During the roping operation, the second rope pulley 302 may initially be roped down from the first rope pulley 701 by means of the first rope 112, until the first roping down region 113 may have been travelled and/or until the coupling element 306 may abut against the abutment (or end stop) 304 (see FIG. 7). Subsequently, the second rope 122 and, accordingly, the persons 101, 301 secured thereto may be roped down from the second rope pulley 302, until the persons 101, 301 to be secured may have reached the ground.

During the roping down along the second roping down region 123, the weight force of the persons 101, 301 to be secured may be transferred via the second rope 122, further via the second rope pulley 302, further via the coupling element 306 and further via the suspension element 124 to the carrier plate 201. After the coupling element 306 may have reached the abutment, the second roping down system may thus be decoupled non-destructively from the first roping down system, because no substantial significant weight force of the persons 101, 301 to be secured may be transferred via the first rope 112.

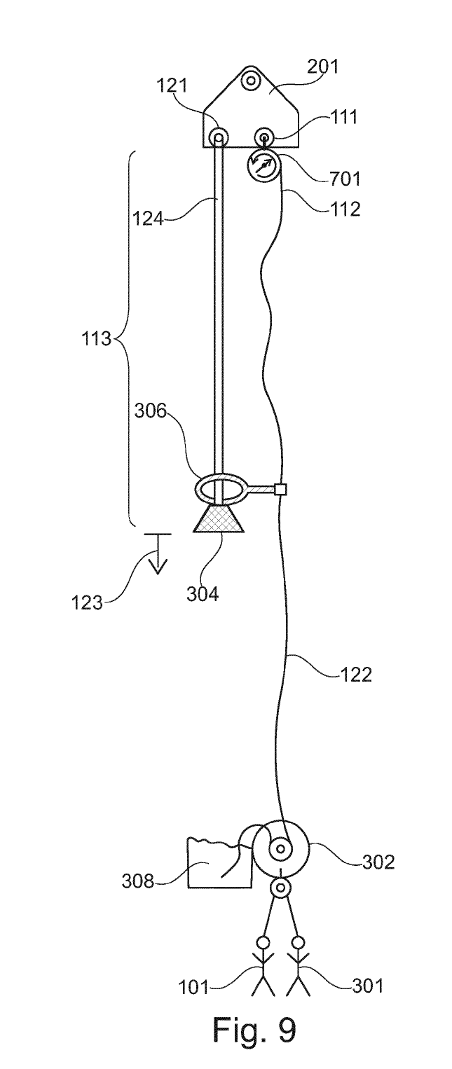

FIG. 9 shows a schematic representation of a further exemplary embodiment, in which the second rope 122 may be attached to the coupling element 306, and the second rope pulley 302 may be displaceable and/or can be roped down relatively to the second rope 122. The first roping down system may be coupled with the second roping down system along the first roping down region 113. This may mean that the coupling element 306 and the second rope pulley 302 can be roped down jointly by means of the first rope 112. To this end, the first rope pulley 701 may specifically rope down the first rope 112.

After reaching the end stop 304 of the suspension element 124, the second roping down system may decouple non-destructively from the first roping down system, such that the weight force of the persons 101, 301 to be secured may be transferred from the second rope 122 via the coupling element 306 to the suspension element 124 and, accordingly, the first rope 112 may be relieved.

The coupling element 306 can be coupled with the second rope pulley 302 for example via a magnetic, mechanical and/or sensor-controlled coupling, such that a non-destructive decoupling can be performed.

Furthermore, the exemplary embodiment in FIG. 9 shows a further stowage device 308 at the second rope pulley 302, in which a section of the second rope 122 between the second rope pulley 302 and the further stowage device 308 can be stowed.

It is to be noted supplementarily, that “having” or “comprising” does not exclude other elements or steps, and that “a” or “an” does not exclude a plurality. Furthermore, it is to be noted that features or steps, which have been described with reference to one of the embodiment examples above, may also be used in combination with other features or steps of other embodiment examples described above.

### LIST OF REFERENCE NUMERALS

100 system
101 person
102 working area
103 roping down device
111 first attachment element
112 first rope
113 first roping down region
121 second attachment element
122 second rope
123 second roping down region
124 suspension element
125 third rope pulley
201 carrier element
202 coupling region
203 stowage device
301 further person
302 second rope pulley
303 further second rope pulley
304 end stop
305 further coupling element
306 coupling element
307 further stowage device
308 further stowage device
501,502 securing elements
701 first rope pulley

1. A system for roping down of a person in an emergency situation in a controlled manner out of a working area located at a distance to a ground, the system comprising:
a first roping down system, which is for roping down the person and which is attachable to an attachment area in the working area, wherein the first roping down system has a first rope for roping down the person;
a second roping down system for roping down the person, wherein the second roping down system has a second rope, to which the person is coupleable;
a suspension element, which is attachable to the attachment area in the working area;
wherein the second roping down system is coupled to the suspension element such that a force-transmitting coupling is producable between the second rope and the suspension element, and
wherein the first roping down system and the second roping down system are designed such that
the second roping down system is coupled in a first roping down region to the first roping down system and the second roping down system can be roped down in the first roping down region from the attachment area along a first roping length by means of the first rope, and such that
the second roping down system is decoupleable non-destructively from the first roping down system as from an end of the first roping down region and the person can be roped down in a second roping down region along a second roping length by means of the second rope, and
wherein a weight force of the person in the second roping down region is transferrable from the second rope via the suspension element to the attachment area.

2. The system according to claim 1, wherein the suspension element has a rail, a cable, or a rope.

3. The system according to claim 1, further having
a roping down device, to which the first rope and the second rope are coupled and to which the person is coupleable,
wherein the roping down device is designed such that the roping down device is displaceable along the first rope and/or the second rope.

4. The system according to claim 1,
wherein the first roping down system comprises a first rope pulley, which is attachable in the working area by means of a first attachment element,
wherein the first rope is coupled to the first rope pulley such that the first rope is unrollable by means of the first rope pulley.

5. The system according to claim 4, wherein the first rope pulley has a first rope brake, which is configured to control an unrolling of the first rope by the first rope pulley.

6. The system according to claim 1,
wherein the second roping down system has a second rope pulley,
wherein the second rope pulley is coupled to the first rope, such that the second rope pulley can be roped down by means of the first rope, and
wherein the second rope is coupled to the second rope pulley such that the second rope can be roped down by means of the second rope pulley.

7. The system according to claim 6,
wherein the second roping down system has a further second rope pulley,
wherein the further second rope pulley is connected to the first rope such that the further second rope pulley can be roped down along the first rope, and
wherein the further second rope pulley is coupled to the second rope pulley.

8. The system according to claim 7,
wherein the further second rope pulley is coupled to the second rope pulley such that the further second rope pulley is fixed to the second rope pulley and that the second rope can be roped down by means of the second rope pulley.

9. The system according to claim 7,
wherein the second rope is attached to the further second rope pulley,
wherein the second rope pulley is coupled via the second rope to the further second rope pulley and can be roped down along the second rope.

10. The system according to claim 6,
wherein the second roping down system has a coupling element,
wherein the coupling element is coupled to the first rope,
wherein the coupling element is further coupled to the suspension element such that the coupling element is displaceable along the suspension element within the first roping down region.

11. The system according to claim 10,
wherein the coupling element is attached to the further second rope pulley such that the coupling element is coupled to the first rope by the further second rope pulley.

12. The system according to claim 10,
wherein the coupling element is coupled to the first rope.

13. The system according to claim 12,
wherein the coupling element is attached to the second rope,
wherein the second rope pulley can be roped down along the second rope.

14. The system according to claim 10,
wherein the suspension element has an end stop arranged at the transition between the first roping down region and the second roping down region, which end stop is designed such that the coupling element is displaceable along the suspension element up to the end stop and is lockable by the end stop.

15. The system according to the claim 14,
wherein the end stop has a damping element, which delays the movement of the coupling element along the suspension element.

16. The system according to claim 1,
wherein the second roping down system has a third rope pulley, which is attached to the suspension element,
wherein the second rope is coupled to the third rope pulley such that the second rope is unrollable from the third rope pulley.

17. The system according to claim 16,
wherein the third rope pulley has a third rope brake, which is configured to control an unrolling of the second rope from the third rope pulley.

18. The system according to claim 1, further having
a carrier element,
wherein the first attachment element and the second attachment element are attachable, in particular at a distance from one another, to the carrier element,
wherein the carrier element has a coupling region, which is designed such that the carrier element is attachable in the working area by means of the coupling region.

19. The system according to claim 1, further having
a stowage device,
wherein the first roping down system and the second roping down system are arrangeable in the stowage device such that the first roping down system and the second roping down system are stowed in the stowage device and that the first attachment element and the second attachment element are attachable in the working area,
wherein the stowage device is designed such that, upon a load of the roping down device, the stowage device releases the first roping down system and the second roping down system.

20. A method for roping down of a person in an emergency situation in a controlled manner out of a working area located at a distance from a ground, the method having the following steps:
attaching a first rope of a first roping down system, which is for roping down the person to an attachment area in the working area,
attaching a suspension element to the attachment area in the working area,
coupling a second roping down system to the suspension element such that a force-transmitting coupling is producable between a second rope of the second roping down system, which is for roping down the person, and the suspension element,
wherein the first roping down system and the second roping down system are arranged such that
the second roping down system is coupled in a first roping down region to the first roping down system and the second roping down system can be roped down in the first roping down region from the attachment area along a first roping length by the first rope, and such that the second roping down system is decoupleable non-destructively from the first roping down system from an end of the first roping down region and the person can be roped down in a second roping down region along a second roping length by means of the second rope, wherein a weight force of the person in the second roping down region is transferable from the second rope via the suspension element to the attachment area.
